(19) United States
(12) Patent Application Publication
(10) Pub. No.: US 2003/0218149 A1
(43) Pub. Date: Nov. 27, 2003

(54) Azeotrope-like compositions of tetrafluoroethane and chlorodifluoroethane

(75) Inventors: Rajiv R. Singh, Getzville, NY (US); Hang T. Pham, Amherst, NY (US); David P. Wilson, East Amherst, NY (US)

Correspondence Address: SYNNESTVEDT & LECHNER, LLP, 2600 ARAMARK TOWER, 1101 MARKET STREET, PHILADELPHIA, PA, 191072950

(73) Assignee: Honeywell International, Inc., Morristown, NJ

(21) Appl. No.: 10/444,908

(22) Filed: May 22, 2003

Related U.S. Application Data
(60) Provisional application No. 60/382,487, filed on May 22, 2002.

(51) Int. Cl. F25D 1/00; C09K 5/00

(52) U.S. Cl. 252/67

(57) ABSTRACT

Disclosed are azeotrope-like compositions comprising 1,1,1,2-tetrafluoroethane and 1-chloro-1,1-difluoroethane, said compositions are environmentally desirable for use as refrigerants, aerosol propellants, metered dose inhalers, blowing agents for polymer foam, heat transfer media, and gaseous dielectrics.

### CROSS REFERENCE TO RELATED APPLICATIONS

The present invention is related to and claims the priority benefit of U.S. provisional application No. 60/382,487, which was filed May 22, 2002 and which is incorporated herein by reference.

### FIELD OF THE INVENTION

The present invention relates to novel compositions comprising tetrafluoroethane and chlorodifluoroethane.

### BACKGROUND

Hydrofluorocarbon-based compositions are of interest for use as replacements for chlorofluorocarbon (“CFC”) compositions, which tend to be environmentally undesirable. In particular, applicants have recognized that compositions comprising mixtures of hydrofluorocarbon (“HFC”) and hydrochlorofluorocarbon (“HCFC”) fluids are of interest for use in a wide range of applications, including for use as refrigerants in air conditioning and refrigeration systems. Unfortunately, applicants have further identified a number of disadvantages associated with adapting typical HFC-based mixtures for use in a variety of applications, including, for example, in refrigeration systems.

One disadvantage associated with the use of many conventional HFC-based mixtures in refrigeration applications is that such mixtures tend to exhibit relatively high “temperature glide” characteristics which tend to render them undesirable or unsuitable for use in conventional refrigeration systems. The “temperature glide” of a refrigerant mixture refers generally to the difference in the starting and ending temperatures of a gas/liquid phase change by a mixture of refrigerant fluids. While it is generally desirable to maintain relatively constant condensation and evaporation temperatures in conventional refrigeration equipment to ensure adequate efficiency of the refrigeration system, an HFC-based mixture having a high temperature glide tends to result in an undesirable variation between condensation and evaporation temperatures, even ignoring pressure drop effects. Accordingly, it is difficult, if not impossible, to achieve an efficient refrigeration system using such HFC-based mixtures.

It has been suggested, for example, in T. Atwood “NARBs—the Promise and the Problem”, paper 86-WA/Ht-61 American Society of Mechanical Engineers, that certain refrigeration systems may be redesigned to provide efficient refrigeration using HFC-based mixtures having relatively high temperature glide characteristics. However, such redesign is both disadvantageously time-consuming and costly.

Applicants have recognized that the use of HFC-based mixtures having azeotropic or azeotrope-like characteristics, which mixtures tend not fractionate on boiling and evaporation, have low (or no) temperature glides and are thus desirable for use in refrigeration applications. However, the identification of new, environmentally safe, non-fractionating mixtures is complicated due to the fact that azeotrope formation is not readily predictable.

Accordingly, applicants have recognized the need for new HFC-based mixtures that offer alternatives to, and are considered environmentally safer substitutes for CFCs. Such mixtures are the subject of this invention.

### DESCRIPTION OF PREFERRED EMBODIMENTS

The present inventors have developed compositions that can help to satisfy the continuing need for substitutes for CFCs. In addition, the present invention helps to satisfy the need for improvements in compositions which contain HCFCs. In preferred embodiments, the present invention provides azeotrope-like compositions comprising 1,1,1,2-tetrafluoroethane (“HFC-134a”) and 1-chloro-1,1,-difluoroethane (“HCFC-142b”).

Applicants preferred compositions provide environmentally desirable replacements for currently used CFCs. One of the environmentally desirable characteristics of the preferred compositions of the present invention is the low ozone depletion potential of the compositions. Additionally, the preferred compositions of the invention exhibit characteristics that make the compositions superior CFC and HCFC substitutes than either of HFC-134a or HCFC-142b alone.

The Compositions

The compositions discovered by applicants are azeotrope-like compositions. As used herein, the term “azeotrope-like” is intended in its broad sense to include both compositions that are strictly azeotropic and compositions that behave like azeotropic mixtures. From fundamental principles, the thermodynamic state of a fluid is defined by pressure, temperature, liquid composition, and vapor composition. An azeotropic mixture is a system of two or more components in which the liquid composition and vapor composition are equal at the state pressure and temperature. In practice, this means that the components of an azeotropic mixture are constant boiling and cannot be separated during a phase change.

As the term is used herein, “azeotrope-like” compositions behave like azeotropic mixtures, that is, they are constant boiling or essentially constant boiling. In other words, for azeotrope-like compositions, the composition of the vapor formed during boiling or evaporation is identical, or substantially identical, to the original liquid composition. Thus, with boiling or evaporation, the liquid composition changes, if at all, only to a minimal or negligible extent. This is to be contrasted with non-azeotrope-like compositions in which, during boiling or evaporation, the liquid composition changes to a substantial degree. All azeotrope-like compositions of the invention within the indicated ranges as well as certain compositions outside these ranges are azeotrope-like.

The azeotrope-like compositions of the invention may include additional components that do not form new azeotropic or azeotrope-like systems, or additional components that are not in the first distillation cut. The first distillation cut is the first cut taken after the distillation column displays steady state operation under total reflux conditions. One way to determine whether the addition of a component forms a new azeotropic or azeotrope-like system so as to be outside of this invention is to distill a sample of the composition with the component under conditions that would be expected to separate a non-azeotropic mixture into its separate components. If the mixture containing the additional component is non-azeotropic or non-azeotrope-like, the additional component will fractionate from the azeotropic or azeotrope-like components. If the mixture is azeotrope-like, some finite amount of a first distillation cut will be obtained that contains all of the mixture components that is constant boiling or behaves as a single substance.

It follows from this that another characteristic of azeotrope-like compositions is that there is a range of compositions containing the same components in varying proportions that are azeotrope-like or constant boiling. All such compositions are intended to be covered by the terms “azeotrope-like” and “constant boiling”. As an example, it is well known that at differing pressures, the composition of a given azeotrope will vary at least slightly, as does the boiling point of the composition. Thus, an azeotrope of A and B represents a unique type of relationship, but with a variable composition depending on temperature and/or pressure. It follows that, for azeotrope-like compositions, there is a range of compositions containing the same components in varying proportions that are azeotrope-like. All such compositions are intended to be covered by the term azeotrope-like as used herein.

One aspect of applicants discovery provides azeotrope-like compositions comprising HFC-134a and HCFC-142b. Preferably, the novel azeotrope-like compositions of the present invention comprise effective amounts of HFC-134a and HCFC-142b. The term “effective amounts” as used herein refers to the amount of each component which upon combination with the other component or components, results in the formation of the present azeotrope-like compositions.

These embodiments preferably provide azeotrope-like compositions comprising, and preferably consisting essentially of, from about 85 to about 99 parts by weight HFC-134a, and from about 1 to about 15 parts by weight HCFC-142b. Preferred compositions are characterized by a boiling point of about −26° C.±2° C., preferably ±1° C., more preferably, ±0.5° C. at 14.7 psia.

The preferred, more preferred, and most preferred compositions of this embodiment are set forth in Table 1. The numerical ranges in Table 1 are to be understood to be prefaced by the term “about”. Unless otherwise specified, all weight percents are based on the total weight of HFC-134a and HCFC-142b.

TABLE 1

| | | More Preferred | Most Preferred |
|---|---|---|---|
| Components | Preferred (wt %) | (wt %) | (wt %) |
| HFC-134a | 85-99 | 90-99 | 95-99 |
| HCFC-142b | 1-15 | 1-10 | 1-5 |

Table 2 provides boiling point data for the HFC-134a/HCFC-142b compositions according to preferred embodiments of the present invention.

TABLE 2

| Wt % 142b (with the remainder being | |
|---|---|
| HFC-134a) | Boiling Pt. (° C. at 14.7 psia) |
| 0 | −26.05 |
| 1.3 | −26.12 |
| 3.7 | −26.27 |
| 5.4 | −26.10 |
| 7.8 | −26.06 |
| 15.6 | −25.81 |
| 20.2 | −24.80 |
| 100 | −9.74 |

Uses of the Compositions

The compositions of the present invention may be used in a wide variety of applications as substitutes for CFCs and HCFCs. For example, the present compositions are useful as refrigerants, solvents, blowing agents, cleaning agents and aerosols.

One embodiment of the present invention relates to a refrigerant comprising one or more azeotrope-like compositions of the present invention. The refrigerant compositions of the present invention maybe used in any of a wide variety of refrigeration systems including air-conditioning, refrigeration, or heat-pump systems. In certain preferred embodiments, the compositions of the present invention may be used in refrigeration systems originally designed for use with a CFC-refrigerant, particularly R-12. The refrigeration compositions of the present invention may be used to retrofit a system containing a lubricant used conventionally with CFC-refrigerants, such as mineral oils, silicone oils, and the like, or may be used with other lubricants traditionally used with HFC refrigerants.

In other embodiments, the present invention provides methods of producing heating or cooling by condensing and/or evaporating a composition of the present invention, and refrigeration systems comprising a refrigerant according to the present invention.

Yet another embodiment of the present invention relates to a blowing agent comprising one or more azeotrope-like compositions of the invention. In other embodiments, the invention provides foamable compositions, and preferably polyurethane and polyisocyanurate foam compositions, and methods of preparing foams. In such foam embodiments, one or more of the present azeotrope-like compositions are included as a blowing agent in a foamable composition, which composition preferably includes one or more additional components capable of reacting and foaming under the proper conditions to form a foam or cellular structure, as is well known in the art. The present methods preferably comprise providing such a foamable composition and reacting it under conditions effective to obtain a foam, and preferably a closed cell foam. The invention also relates to foam, and preferably closed cell foam, prepared from a polymer foam formulation containing a blowing agent comprising the azeotrope-like composition of the invention.

Any of the methods well known in the art, such as those described in “Polyurethanes Chemistry and Technology,” Volumes I and II, Saunders and Frisch, 1962, John Wiley and Sons, New York, N.Y., which is incorporated herein by reference, may be used or adapted for use in accordance with the foam embodiments of the present invention. In general, such preferred methods comprise preparing polyurethane or polyisocyanurate foams by combining an isocyanate, a polyol or mixture of polyols, a blowing agent or mixture of blowing agents comprising one or more of the present compositions, and other materials such as catalysts, surfactants, and optionally, flame retardants, colorants, or other additives. It is convenient in many applications to provide the components for polyurethane or polyisocyanurate foams in pre-blended formulations. Most typically, the foam formulation is pre-blended into two components. The isocyanate and optionally certain surfactants and blowing agents comprise the first component, commonly referred to as the “A” component. The polyol or polyol mixture, surfactant, catalysts, blowing agents, flame retardant, and other isocyanate reactive components comprise the second component, commonly referred to as the “B” component. Accordingly, polyurethane or polyisocyanurate foams are readily prepared by bringing together the A and B side components either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, and even other polyols can be added as a third stream to the mix head or reaction site. Most conveniently, however, they are all incorporated into one B-component as described above.

It is also possible to produce thermoplastic foams using the compositions of the invention. For example, conventional foam polyurethanes and isocyanurate formulations may be combined with the azeotrope-like compositions in a conventional manner to produce rigid foams.

Azeotrope-like mixtures containing HFC-134a in accordance with the present invention are particularly suitable as foam blowing agents since foams blown with HFC-134a have been found to possess low relative initial and aged thermal conductivity and good dimensional stability at low temperatures. Of particular interest are those azeotrope-like compositions of the present invention that optionally further contain other zero ozone depleting materials, such as, for example, other hydrofluorocarbons, e.g., difluoromethane (HFC-32); difluoroethane (HFC-152); trifluoroethane (HFC-143); tetrafluoroethane (HFC-134); pentafluoroethane (HFC-125); pentafluoropropane (HFC-245); hexafluoropropane (HFC-236); heptafluoropropane (HFC-227); pentafluorobutane (HFC-365) and inert gases, e.g., air, nitrogen, carbon dioxide. Where isomerism is possible for the hydrofluorocarbons mentioned above, the respective isomers may be used either singly or in the form of a mixture.

Dispersing agents, cell stabilizers, and surfactants may also be incorporated into the blowing agent mixture. Surfactants, better known as silicone oils, are added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458, each of which is incorporated herein by reference. Other optional additives for the blowing agent mixture may include flame retardants such as tri(2-chloroethyl)phosphate, tri(2-chloropropyl)phosphate, tri(2,3-dibromopropyl)-phosphate, tri(1,3-dichloropropyl)phosphate, diammonium phosphate, various halogenated aromatic compounds, antimony oxide, aluminum trihydrate, polyvinyl chloride, and the like.

In another embodiment, the azeotrope-like compositions of this invention may be used as propellants in sprayable compositions, either alone or in combination with known propellants. The propellant composition comprises, more preferably consists essentially of, and, even more preferably, consists of the azeotrope-like compositions of the invention. The active ingredient to be sprayed together with inert ingredients, solvents, and other materials may also be present in the sprayable mixture. Preferably, the sprayable composition is an aerosol. Suitable active materials to be sprayed include, without limitation, cosmetic materials such as deodorants, perfumes, hair sprays, cleansers, and polishing agents as well as medicinal materials such as anti-asthma and anti-halitosis medications.

In another process embodiment, a process for removing HCFC-142b from HFC-134a is provided, which process comprises the step of distilling a mixture of HFC-134a and HCFC-142b to separate an azeotrope or azeotrope-like composition consisting essentially of HFC-134a and HCFC-142b from HFC-134a present in excess of the concentration of said azeotrope. Thus, the azeotrope can be used to remove bulk amounts of HFC-142b in a HFC-134a manufacturing process.

The components of the composition of the invention are known materials that are commercially available or may be prepared by known methods. Preferably, the components are of sufficiently high purity so as to avoid the introduction of adverse influences upon cooling or heating properties, constant boiling properties, or blowing agent properties of the system. In the case of metered dose inhalers, the relevant current Good Manufacturing Process may be used for manufacturing these materials.

Additional components may be added to adjust the properties of the azeotrope-like compositions of the invention as needed. By way of example, oil solubility aids may be added in the case in which the compositions of the invention are used as refrigerants. Stabilizers and other materials may also be added to enhance the properties of the compositions of the invention.

### EXAMPLES

### Example 1

An ebulliometer consisting of vacuum jacketed tube with a condenser on top is used. About 20 g HFC-134a is charged to the ebulliometer and then HCFC-142b is added in small, measured increments. Temperature depression is observed when HCFC-142b is added to HFC-134a, indicating a binary minimum boiling azeotrope is formed. From greater than about 0 to about 15 weight percent HCFC-142b, the boiling point of the composition changes by about 1° C. or less. The binary mixtures shown in Table 1 are studied and the boiling point of the compositions change by about 1° C. or less. The compositions exhibit azeotrope and/or azeotrope-like properties over this range.

### Examples 2-5

These examples illustrate the efficiency of the present compositions in refrigeration systems.

The performance of a refrigerant at specific operating conditions can be estimated from the thermodynamic properties of the refrigerant using refrigeration cycle analysis techniques; see for example, R. C. Downing, FLUOROCARBOR REFRIGERANTS HANDBOOK, Chapter 3, Prentice-Hal, 1988. The coefficient of performance (COP) is a universally accepted measure, especially useful in representing the relative thermodynamic efficiency of a refrigerant in a specific heating or cooling cycle involving evaporation or condensation of the refrigerant. In refrigeration engineering, this term expresses the ratio of useful refrigeration to the energy applied by the compressor in compressing the vapor. The capacity of a refrigerant represents the volumetric efficiency of the refrigerant. To a compressor engineer, this value expresses the capability of a compressor to pump quantities of heat for a given volumetric flow rate of refrigerant. In other words, given a specific compressor, a refrigerant with a higher capacity will deliver more cooling or heating power.

Four compositions of the present invention (E2-E5) having the weight percent compositions shown in Table 3 are prepared and the COP and capacity for systems containing such compositions are determined for a refrigeration/air-conditioning cycle where the average condenser temperature is about 120° F., with expansion occurring at about 110 F, and the evaporator temperature is about 35° F., with outlet temperature being about 40 F. For the calculations, the following is assumed: isentropic compression and a compressor inlet temperature of 45° F. Table 3 below lists the COP and capacity of the various blends relative to that of HFC-134a over a range of condenser and evaporator temperatures.

TABLE III

| | | | DISCHARGE |
|---|---|---|---|
| COMPOSITION | | | TEMPERATURE |
| HFC-134a/ | COP | CAPACITY | (° F.) |
| E2-99/1 | 1.00 | 1.00 | 138 |
| E3-95/5 | 1.00 | 1.01 | 138 |
| E4-90/10 | 1.00 | 0.99 | 138 |
| E5-85/15 | 1.01 | 0.95 | 138 |

### Example 6

One hundred (100) g of a polyether with a hydroxyl value of 380, a result from the addition of propylene oxide to a solution of saccharose, propylene glycol and water, is mixed with 2 g of a siloxane polyether copolymer as foam stabilizer, and 3 g of dimethylcyclohexylamine. With stirring, 100 g of the mixture is thoroughly mixed with 15 g of an azeotrope-like composition of Example 1 as blowing agent. The resulting mixture is foamed with 152 g of crude 4,4′ diisocyanatodiphenylmethane. The resulting rigid foam is inspected and found to be of good quality.

What is claimed is:

1. An azeotrope-like composition comprising from about 85 to about 99 weight percent 1,1,1,2-tetrafluoroethane and from about 1 to about 15 weight percent of 1-chloro-1,1-difluoroethane.

2. The azeotrope-like composition of claim 1 having a constant boiling point of about −26° C. ±1° C. at about 14.7 psia.

3. The azeotrope-like composition of claim 2 comprising from about 90 to about 99 weight percent 1,1,1,2-tetrafluoroethane and from about 1 to about 10 weight percent of 1-chloro-1,1-difluoroethane.

4. The azeotrope-like composition of claim 3 comprising from about 95 to about 99 weight percent 1,1,1,2-tetrafluoroethane and from about 1 to about 5 weight percent of 1-chloro-1,1-difluoroethane.

5. A refrigerant comprising an azeotrope-like composition of claim 1.

6. A refrigeration system comprising a refrigerant of claim 5.

7. A method for producing refrigeration which comprises condensing a refrigerant composition of claim 5 and thereafter evaporating said refrigerant composition in the vicinity of the body to be cooled.

8. A method for producing heating which comprises condensing a refrigerant composition of claim 5 in the vicinity of the body to be heated and thereafter evaporating said refrigerant composition.

9. A method for producing a foam comprising foaming a composition containing an azeotrope-like composition of claim 1.

10. A premix of a polyol and a blowing agent comprising a composition of claim 1.

11. A closed cell foam composition prepared by foaming a foamable composition containing an azeotrope-like composition of claim 1.

12. A blowing agent comprising an azeotrope-like composition of claim 1.

13. A sprayable composition comprising a material to be sprayed and a propellant comprising an azeotrope-like composition of claim 1.

14. A sprayable composition according to claim 13 wherein the sprayable composition is an aerosol.

15. A sprayable composition according to claim 13 wherein the sprayable composition is a cosmetic material.

16. A sprayable composition according to claim 13 wherein the material to be sprayed is a medicinal material.
